(19) United States
(12) Patent Application Publication
(10) Pub. No.: US 2009/0257680 A1
(43) Pub. Date: Oct. 15, 2009

(54) Method and Device for Video Stitching

(75) Inventors: Harsh Dhand, Mohali (IN); Srihari Sukumaran, Kochi (IN)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/306,913

(22) PCT Filed: Jun. 19, 2007
(86) PCT No.: PCT/IB2007/052352

§ 371 Date: Dec. 29, 2008

(30) Foreign Application Priority Data
Jun. 30, 2006 (EP) 06116472.9

(51) Int. Cl. G06K 9/36

(52) U.S. Cl. 382/284

(57) ABSTRACT

A method and device for video stitching is presented. The invention determines one or more motion vectors indicative of changes in two consecutive images of a (video) sequence of images. It further determines a spatial correlation function by examining two images from two different videos obtained from adjacently placed cameras having an overlapping field of view and that are to be combined. The invention achieves a faster stitching of images by applying the correlation function for combining subsequent set/s of images, subject to a match value being in a predetermined range. The match-value is a value indicative of a change in the correlation function for the subsequent set of images that are to be combined. Said match value is determined according to sets of coordinate values which are indicative of an overlapping portion in the subsequent set of images that are to be combined and the correlation function. The sets of coordinate values are determined according to the motion vectors.

The invention relates to a method and a device for video stitching. The invention further related to a computer program product.

Definition 1: For the sake of brevity, simplicity, clarity and exemplification, hereinafter, only two videos are considered to explain generation of a mosaic video from a plurality of videos; however a person skilled in the art will appreciate that the same explanation can be extended to more than two videos as well.

Many applications including surveillance systems, videoconference vision systems, domestic video applications, vehicle vision systems and other systems require a wide viewing angle for obtaining a an easy comprehension of events occurring in the angle. However, typically a viewing angle of a normal camera is limited to a maximum of 90 degrees in the horizontal plane. A plurality of adjacently placed cameras is frequently used for widening of the viewing angle. Images/Videos obtained by these cameras are stitched together to construct a panoramic or a mosaic image/video to achieve a wide viewing angle. Obtaining a panoramic or a mosaic image/video is a computationally expensive and time consuming affair. Usually obtaining a panoramic or a mosaic video is not possible in real time because of the computational time required for generating it.

US Patent application 2006/0066730 (hereinafter referred as D1) describes a multi-camera image stitching for a distributed aperture system. According to D1 the system uses multiple staring sensors distributed around a vehicle to provide automatic detection of targets, and to provide an imaging capability at all aspects. The system determines a line of sight and a field of view, obtains a collection of input images for mosaic and maps contribution from input images to mosaic. This system requires expensive computational resources, and provides a time inefficient solution.

Therefore, it is advantageous to have a time and resource efficient image or video stitching system.

To this end, the invention provides a method for generating a series of mosaic images from at least a first and a second series of images comprising the steps of:

a. obtaining a first motion vector from the first series of images and a second motion vector from the second series of images;
b. extracting a first set of coordinate values from a first image of the first series of images and a second set of coordinate values from a first image of the second series of images, wherein said first and second sets correspond to an overlapping portion of the first images;
c. obtaining a correlation function from said sets, said correlation function being indicative of a relation between coordinate values of the first images;
d. combining the first image of the first series of image and the first image of the second series of images using the correlation function;
e. updating the motion vectors using a second image of the first series and a second image of the second series, which second images follow the first images;
f. extracting the sets of coordinate values for the second images if at least one motion vector has a magnitude greater than a threshold value, else updating the sets of coordinate values using the motion vectors and the sets of coordinate values for the second images;
g. computing a match value using the sets of coordinate values and the correlation function;
h. if the match value is within a predetermined range of values,
combining the second image of the first series of images and the second image of the second series of images using the correlation function and,
repeating the method from step e onwards, wherein a consecutively following image of the second image of the first series takes the place of the second image of the first series and a consecutively following image of the second image of the second series takes the place of the second image of the second series and;
   i. repeating the method from step b onwards, wherein the second image of the first series takes the place of the first image of the first series, and the second image of the second series takes the place of the first image of the second series.

This aspect of the method according to the invention uses the fact that a video is a sequence of images and a motion vector can be indicative of changes in two consecutive images of the sequence of images. Further, generating a mosaic video from a plurality of videos requires sequential combining of images obtained from the plurality of videos. A spatial correlation function may be derived from images from mutually different videos obtained from adjacently placed cameras having an overlapping field of view. The present invention achieves a faster stitching of images by computing a correlation function by examining images that need to be combined and applying the correlation function also for combining subsequent set/s of images provided that a match value is in a predetermined range. The match-value is a value indicative of a change in the correlation function for the subsequent set of images that are to be combined. Said match value is determined according to sets of coordinate values indicative of an overlapping portion in the subsequent set of images to be combined and the correlation function. The motion vectors are updated for the subsequent set of images. The updated motion vectors represent a change in the subsequent set of images in comparison to the images that were combined in the preceding step. The sets of coordinate values are determined according to the motion vectors. That means the coordinates of a mutually overlapping portion in a subsequent set of images are obtained by appropriately adding the motion vector to the set of coordinates of the overlapping portion of the images which has been combined in the preceding step. Only if any one of the motion vectors has a magnitude more than a threshold value a new set of coordinates is obtained from the subsequent images. The present invention therewith avoids a need for repeated computation of a correlation function for each pair of images that are to be combined.

A motion vector of a video (or a sequence of images) can be determined by examining a first number of images of the sequence of images. An average change in coordinate values of a feature per image may represent a motion vector. The motion vector may also be determined by an optical flow method. For computing a correlation function, two images that are to be combined are obtained. In both the images coordinate values of feature representing an overlapping portion are determined. A correlation function representing a relation amongst the coordinate values of an overlapping portion of the two images is obtained. A method, such as, random sample consensus analysis or an analysis of a system of over-determined matrices may be used for obtaining the correlation function. The two images are then combined using the correlation function. Subsequently, the motion vectors are updated using a subsequent set of images that are to be combined. If a magnitude of the updated motion vector is less than a threshold value then, the motion vectors and the coordinate values obtained from the two images are used to estimate coordinate values of features corresponding to an overlapping portion in the subsequent set of images. If this is not the case then, a fresh set of coordinate values are determined for the subsequent set of images. Checking for the magnitude of the motion vectors ensures that the coordinate values obtained for a subsequent set of images is an exact or substantially exact representation of an overlapping portion of the images. The coordinate values of one of the subsequent set of images when applied with the correlation function should provide coordinate values of the features corresponding to the estimated coordinate values of overlapping portion in the other image of the subsequent set of images. However, practically this may not be the case due to the errors introduced during computation of the correlation function and motion vectors or due the video capturing device/s itself/themselves. Therefore, a tolerable match value is estimated according to a desired quality of the mosaic image. Whenever, the estimated coordinate values of one of the subsequent set of images, on application of the correlation function provides coordinate values that substantially (more than the match value) differ from the estimated coordinate values of the overlapping portion in the other image of the subsequent image, then a fresh process of determining the correlation function is followed for the subsequent set of images. If this is not the case then the same correlation function is used for combining the subsequent set of images and following set of images until the difference is within the match value.

According to an aspect, the invention provides a device comprising: a processing unit having one or more input and one or more outputs. The device is arranged for receiving a plurality of series of input images and for providing one or more mosaic series of output images according to the steps described above. The device according to one embodiment may have a communication facility for communicating input and/or output series of images. The communication facility may be a wired communication facility or a wireless communication facility or any combination thereof. Providing such facility with the device allows communication of the images (or series of images) to/from the device to/from nearby or remote locations.

According to another aspect of the invention a computer program product is provided. The computer program product may be loaded by a computer arrangement, comprising instructions for generating a series of mosaic images, the computer arrangement comprising a processing unit and a memory, the computer program product, after being loaded, providing said processing unit with the capability to carry out the steps described above.

Embodiments of the invention will be now discussed in more detail hereinafter with reference to the enclosed drawings, wherein:

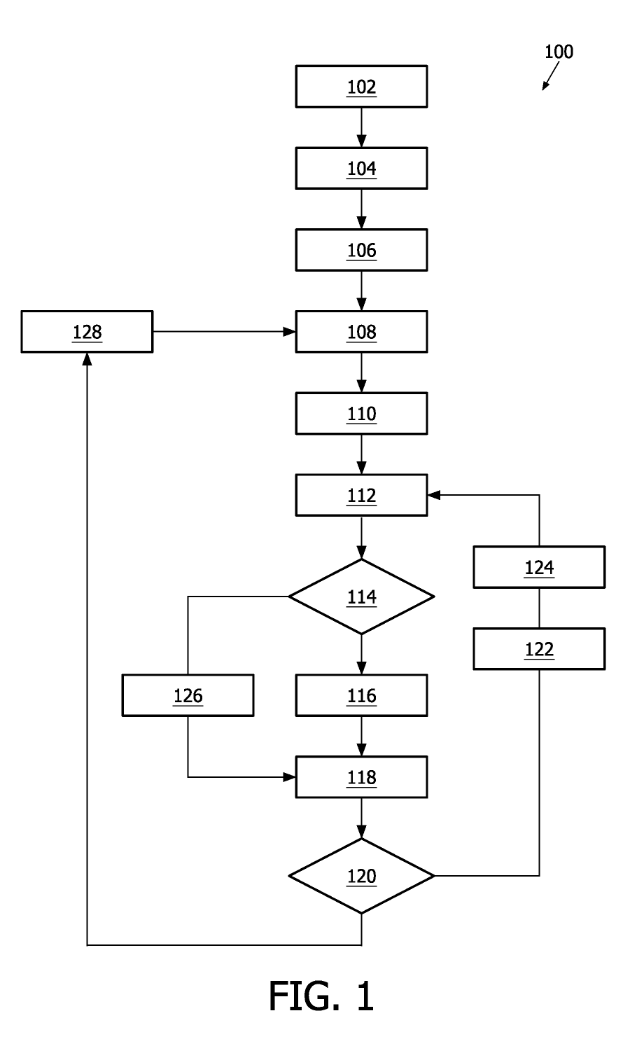

FIG. 1 shows a flow diagram of a method in accordance with an embodiment of the invention;

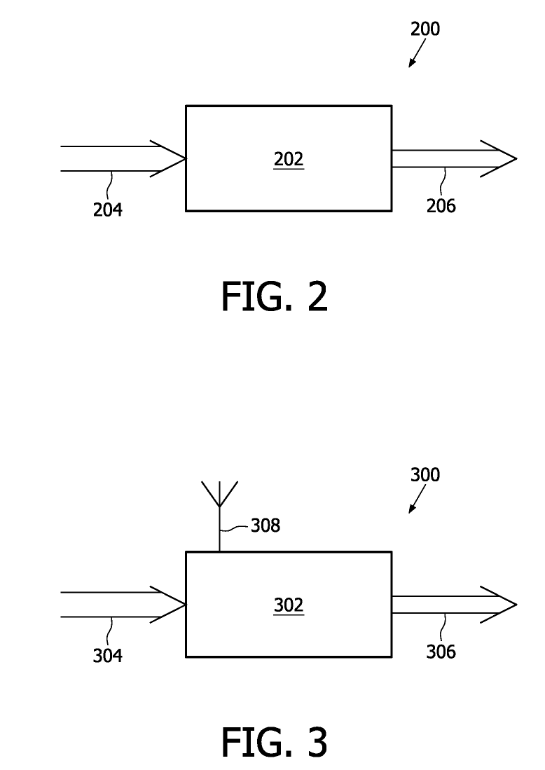

FIG. 2 shows a device in accordance with an embodiment of invention;

FIG. 3 shows another device in accordance with a further embodiment of the invention, and;

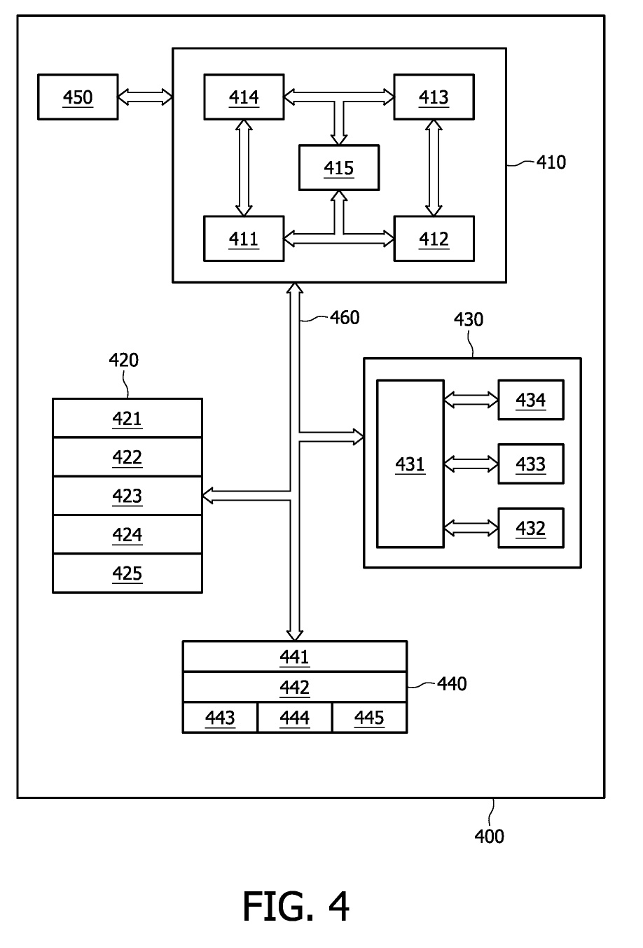

FIG. 4 shows one of the possible Application Specific Integrated Circuit (ASIC) implementations of a device in accordance with a still further embodiment of the invention.

FIG. 1 shows steps 100 followed for practicing the method according to an embodiment of the invention. In the first step 102 at least a first and a second series of images is obtained. A series of mosaic images is required to be generated from said first and second series of images. In step 104 a first motion vector from the first series of images and a second motion vector from the second series of images are obtained.

According to one embodiment the motion vector may be obtained using a block correlation method. In this method an image is partitioned in blocks of features (e.g. macro blocks of 16×16 features in MPEG). Each block in a first image corresponds to a block of equal size in a second image. A block in the first image may observe a shift in its position in the second images. This shift is represented by a motion vector. Hence, the motion vector may be computed by taking the difference in coordinate values of matching blocks in the two images. The motion vector may further be optimized using DCT on the blocks. This is called phase correlation; a frequency domain approach to determine the relative translative movement between two images. According to another embodiment the motion vector may be obtained using optical flow method.

In step 106, a first set of coordinate values from a first image of the first series of images and a second set of coordinate values from a first image of the second series of images is extracted. Said first and second sets correspond to an overlapping portion of the first images.

In the subsequent step 108 a correlation function from said sets, said correlation function being indicative of a relation between coordinate values of the first images. For given sets of coordinate values a correlation function may be obtained as follows.

If the obtained set of coordinate values are represented by (x, y, 1) and (x′, y′, 1), then the correlation function H may be obtained by solving following equation. Where, the correlation function H is a 3×3 matrix.

$$[ \begin{matrix}x \\ y \\ 1\end{matrix} ] = H * [ \begin{matrix}{x}^{′} \\ {y}^{′} \\ 1\end{matrix} ] \\ [ \begin{matrix}x \\ y \\ 1\end{matrix} ] = [ \begin{matrix}{h}_{11} & {h}_{12} & {h}_{13} \\ {h}_{21} & {h}_{22} & {h}_{23} \\ {h}_{31} & {h}_{32} & {h}_{33}\end{matrix} ] * [ \begin{matrix}{x}^{′} \\ {y}^{′} \\ 1\end{matrix} ]$$

$$x = \frac{{h}_{11} {x}^{′} + {h}_{12} {y}^{′} + {h}_{13}}{{h}_{31} {x}^{′} + {h}_{32} {y}^{′} + {h}_{33}} ;$$

$$y = \frac{{h}_{21} {x}^{′} + {h}_{22} {y}^{′} + {h}_{23}}{{h}_{31} {x}^{′} + {h}_{32} {y}^{′} + {h}_{33}}$$

On rearranging above

[x′y′1000−xx′−xy′−x]*h=0 (1)

[x′y′1000−xy′−yy′−y]*h=0 (2)

where h=[h₁₁ h₁₂ h₁₃ h₂₁ h₂₂ h₂₃ h₃₁ h₃₂ h₃₃]^{T}

The correlation function may be obtained by solving above equations for a plurality of coordinate values.

In the step 110 the first image of the first series of image and the first image of the second series of images are combined using the correlation function. In a further step 112 the motion vectors are updated using a second image of the first series and a second image of the second series, which second images follow the first images. In subsequent step 114, it is determined if a magnitude of at least a motion vector is more than a threshold value. Determining the magnitude of the motion vector determines the change in the feature location in the subsequent image. If the motion vector has a magnitude more than the threshold value, that is, the feature locations have change position substantially. In the case when magnitude of at least one of the motion vectors is more than the threshold value then, the sets of coordinate values for the second images are extracted 126 in the similar manner as explained in the step 106, except the first images are replaced by the second images. If the magnitude of the motion vector is within threshold value then, the sets of coordinate values are updated 116 using the motion vectors. The updated sets of coordinate values represent an overlapping portion of the second images. The second images follow the first images. For obtaining an updated coordinate value from a coordinate value, a motion vector is added or subtracted to or from the coordinate value.

Once a new set of coordinate values are available a match value E is computed 118. For given sets of coordinate values and the correlation function a match value E may be computed as follows:

$$E = [ \begin{matrix}x \\ y \\ 1\end{matrix} ] - H * [ \begin{matrix}{x}^{′} \\ {y}^{′} \\ 1\end{matrix} ]$$

The match value E determines whether the correlation function is still valid for the second image. If the match value E is small enough, less than a predetermined value (step 120) then the second image is combined using the same correlation function (step 122) and the method is repeated from step 112 onwards wherein a consecutively following image of the second image of the first series takes the place of the second image of the first series and a consecutively following image of the second image of the second series takes the place of the second image of the second series (step 124).

The method is repeated from step 108 onwards if the match value is more than the predetermined value, wherein the second image of the first series takes the place of the first image of the first series, and the second image of the second series takes the place of the first image of the second series.

FIG. 2 shows a device 200 according to an embodiment of the invention. The device 200 has a processing unit 202 and has one or more inputs 204 as well as one or more outputs 206. The processing unit 202 of the device 200 is arranged for receiving a plurality of series of input images and generate and provide at the output one or more mosaic series of images. The processing unit is arranged for carrying out the steps of the method described with reference to FIG. 1.

FIG. 3 shows a further device 300 according to a further embodiment of the invention. The device 300 is provided with a communication facility 308 for communicating input and/or output series of images. The communication facility 308 may be a wired communication facility or a wireless communication facility or any combination thereof. Providing such facility with the device allows communication of the images (or series of images) to/from the device to/from nearby or remote locations. The device 300 has an input 304 and an output 306 for providing/receiving output/input images by a wired communication facility. The device 300 is provided with a processing unit that is arranged for carrying out the steps of the method described with reference to FIG. 1.

According to a still further embodiment the invention may be implemented in an ASIC. FIG. 4 shows one such ASIC 400 implementation. The ASIC 400 may comprise a microprocessor/microcontroller 410 (hereinafter, the wording microprocessor will represent both microcontroller and/or microprocessor) connected through a system bus 460. The system bus 460 also connects an ASIC controller 420, a memory architecture 430 and an external periphery. The microprocessor 410 may be further provided with a test facility 450. The test facility 450 may be a JTAG boundary scan mechanism. The microprocessor 410 includes a module 411 for motion vector computation from a series of images, a feature coordinate values extraction module 412 for extracting feature coordinate values from two or more images, a correlation function computation module 413 for computing a correlation function from the coordinate values, a image stitching module 414 for stitching images using the correlation function and a central logic 415 for controlling above modules. The central logic 415 may be implemented using FPGA (field programmable gate array). Implementing central logic module 415 using FPGA provides flexibility to control the quality of the stitching.

The ASIC controller 420 may include a timer 421, a power management system 422, a Phase Locked Loop control 423, a system flags 424 and other vital system status symbols controlling module 425 e.g. interrupts etc. for governing operation of the ASIC.

The memory architecture 430 may include a memory controller 431 and one or more type of memories, for example a flash memory 432, an SRAM 433, an SIMD memory and other memories. The memory controller 431 allows an access of these memories to the microprocessor 410.

The external periphery 440 includes module for communication to outside the ASIC 400. The communication modules may include wireless communication module 441, a wired communication module 442. These communication modules may use the communication facilities, such as, USB (Universal Serial Bus) 443, Ethernet 444, RS-232 (445) or any other facility.

According to another aspect of the invention a computer program product is provided. The computer program product may be loaded by a computer arrangement, comprising instructions for generating a series of mosaic images, the computer arrangement comprising a processing unit and a memory, the computer program product, after being loaded, providing said processing unit with the capability to carry out the steps described above.

The order in the described embodiments of the method and device of the current discussion is not mandatory, and is illustrative only. A person skilled in the art may change the order of steps or perform steps concurrently using threading models, multi-processor systems or multiple processes without departing from the concept as intended by the current discussion. Any such embodiment will fall under the scope of the discussion and is a subject matter of protection. It should be noted that the above-mentioned embodiments illustrate rather than limit the method and device, and that those skilled in the art will be able to design many alternative embodiments without departing from the scope of the appended claims.

Although the appended claims are directed to particular combinations of features, it should be understood that the scope of the disclosure of the present invention also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention.

The applicant hereby gives notice that new claims may be formulated to such features and/or combinations of such features during the prosecution of the present application or of any further application derived therefrom.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The method and device can be implemented by means of hardware comprising several distinct elements, and by means of a suitably programmed computer. In the device claims enumerating several means, several of these means can be embodied by one and the same item of computer readable software or hardware. The mere fact that certain measures are recited in mutually different dependent claims does not indicate that a combination of these measures cannot be used to advantage.

1. A method for generating a series of mosaic images from at least a first and a second series of images comprising the steps of:
a) obtaining a first motion vector from the first series of images and a second motion vector from the second series of images;
b) extracting a first set of coordinate values from a first image of the first series of images and a second set of coordinate values from a first image of the second series of images, wherein said first and second sets correspond to an overlapping portion of the first images;
c) obtaining a correlation function from said sets, said correlation function being indicative of a relation between coordinate values of the first images;
d) combining the first image of the first series of images and the first image of the second series of images using the correlation function;
e) updating the motion vectors using a second image of the first series and a second image of the second series, which second images follow the first images;
f) extracting the sets of coordinate values for the second images if at least one motion vector has a magnitude greater than a threshold value, else updating the sets of coordinate values using the motion vectors and the sets of coordinate values for the second images;
g) computing a match value using the sets of coordinate values and the correlation function;
h) if the match value is within a predetermined range of values,
combining the second image of the first series of images and the second image of the second series of images using the correlation function and,
repeating the method from step e onwards, wherein a consecutively following image of the second image of the first series takes the place of the second image of the first series and a consecutively following image of the second image of the second series takes the place of the second image of the second series and;
i) repeating the method from step b onwards, wherein the second image of the first series takes the place of the first image of the first series, and the second image of the second series takes the place of the first image of the second series.

2. The method as claimed in claim 1 wherein said predetermined value and said threshold value depend on a required quality of a mosaic image.

3. The method as claimed in claim 1 wherein the step of obtaining a motion vector includes the step of obtaining a first number of images from a series of images and determining an average change of coordinate values of a feature per image and/or determining an optical flow.

4. The method as claimed in claim 1 wherein the step of obtaining a correlation function includes the step of carrying out a random sample consensus algorithm.

5. A device comprising: a processing unit having an input and an output, said device being arranged for receiving a two or more series of input images and provide one or more mosaic series of output images according to the method of claim 1.

6. The device according to claim 5, further comprising a communication facility for communicating input and/or output series of images.

7. A computer program product to be loaded by a computer arrangement, the computer arrangement comprising a processing unit and a memory, the computer program product comprising instructions for generating a series of mosaic images, and after being loaded, providing said processing unit with the capability to carry out the steps of claim 1.
